(19) United States
(12) Patent Application Publication
(10) Pub. No.: US 2023/0322111 A1
(43) Pub. Date: Oct. 12, 2023

(54) INFORMATION PROCESSING APPARATUS, INFORMATION PROCESSING METHOD, AND INFORMATION PROCESSING SYSTEM

(71) Applicant: SONY GROUP CORPORATION, TOKYO (JP)

(72) Inventor: MASANORI OKAZAKI, TOKYO (JP)

(21) Appl. No.: 18/042,507

(22) PCT Filed: Jul. 29, 2021
(86) PCT No.: PCT/JP2021/028156

§ 371 Date: Feb. 22, 2023

(30) Foreign Application Priority Data
Sep. 3, 2020 (JP) 2020-148467

(51) Int. Cl. B60L 53/62; B60L 50/60; G01C 21/34

(52) U.S. Cl. CPC B60L 53/62; B60L 50/60; G01C 21/3469; B60L 2240/60; B60L 2240/26; B60L 2240/647; B60L 2240/66

(57) ABSTRACT

Provided are an information processing apparatus, an information processing method, and an information processing system that control an amount of power to be charged in to a storage battery in a mobile body.

An information processing apparatus according to the present disclosure includes a control unit that controls an amount of power charged into a storage battery on the basis of environment information of a path along which a mobile body that moves by using power accumulated in the storage battery moves, the environment information being acquired after start of charge into the storage battery or after charge start instruction.

### TECHNICAL FIELD

The present disclosure relates to an information processing apparatus, an information processing method, and an information processing system.

### BACKGROUND ART

A storage battery mounted on a mobile body such as an autonomous mobile robot deteriorates quickly if maintaining a fully charged state or a state close to the fully charged state (hereinafter, full charge or the like). Furthermore, if the fully charged storage battery is further charged, the storage battery is overcharged and damaged. Note that, in a case of overcharge, a protection circuit in the storage battery operates to fuse a charge/discharge path to avoid smoke and fire, but in this case as well, damage to the storage battery cannot be avoided. For this reason, it is desirable to control a charge state with some means so that the storage battery is not fully charged or the like. Normally, a mobile mechanism of an autonomous mobile robot is not provided with a brake for deceleration. Therefore, the storage battery may be charged with power regenerated by a motor while the autonomous mobile robot moves on a downward slope, and may be fully charged or the like. For this reason, the autonomous mobile robot is required to be provided with a load resistance apparatus for consuming power regenerated from the motor in a case where the storage battery is fully charged.

Patent Document 1 below discloses a technique for predicting, from map information and a travel result of past, a regenerative power amount at a time of traveling, and limiting an amount of charge into a storage battery on the basis of the predicted regenerative power amount. However, in a case where an actual travel environment is different from a state in the past, the predicted amount of power may greatly deviate from an actual regenerative power amount, and the storage battery may be fully charged or the like, or conversely, an amount of charge necessary for traveling may be insufficient (the storage battery may run out of charge).

### CITATION LIST

### Patent Document

Patent Document 1: Japanese Patent Application Laid-Open No. 2011-188667

### SUMMARY OF THE INVENTION

### Problems to be Solved by the Invention

The present disclosure provides an information processing apparatus, an information processing method, and an information processing system that control an amount of power to be charged into a storage battery in a mobile body.

### Solutions to Problems

An information processing apparatus according to the present disclosure includes a control unit that controls an amount of power charged into a storage battery on the basis of environment information of a path along which a mobile body that moves by using power accumulated in the storage battery moves, the environment information being acquired after start of charge into the storage battery or after charge start instruction.

An information processing method according to the present disclosure controls an amount of power charged into a storage battery on the basis of environment information of a path along which a mobile body that moves by using power accumulated in the storage battery moves, the environment information being acquired after start of charge into the storage battery or after charge start instruction.

An information processing system according to the present disclosure includes a mobile body that is equipped with a storage battery and moves by using power accumulated in the storage battery, a charge unit that charges the storage battery, and a control unit that controls an amount of power charged into the storage battery on the basis of environment information of a path along which the mobile body moves, the environment information being acquired after start of charge into the storage battery or after charge start instruction.

### BRIEF DESCRIPTION OF DRAWINGS

FIG. 1 is an overall system configuration diagram including a charge control system that is an information processing system according to a first embodiment.

FIG. 2 is a view illustrating a state where a robot is coupled to a charge station.

FIG. 3 is a diagram schematically illustrating a plurality of paths in a travel environment and a status in which the robot is charged from the charge station.

FIG. 4 is a diagram illustrating an example of a charge control table used for determining a target charge state.

FIG. 5 is a diagram illustrating an example of calculating a degree of congestion.

FIG. 6 is a flowchart of an example of operation of the charge control system according to the first embodiment.

FIG. 7 is a diagram illustrating a modification of the charge control system according to the embodiment in FIG. 1.

FIG. 8 is a flowchart of an example of operation of a charge control system according to a second embodiment.

FIG. 9 is a diagram illustrating specific examples of judging whether or not a path is passable.

FIG. 10 is a diagram illustrating an example of estimating a carrying speed.

FIG. 11 is a flowchart of an example of processing of judging whether or not a target path is a passable path.

FIG. 12 is a diagram illustrating an example in which a plurality of items X1 to X5 is weighted for Office, Factory, Outdoor site, and Outdoor public/private road as travel environments.

FIG. 13 is a flowchart of an example of operation of a charge control system according to a fourth embodiment.

### MODE FOR CARRYING OUT THE INVENTION

Hereinafter, embodiments of the present disclosure will be described with reference to the drawings. In one or more embodiments set forth in the present disclosure, members included in each embodiment can be combined with each other, and a result from the combination also forms a part of the embodiments set forth in the present disclosure. In the drawings, the same or corresponding members will be denoted by the same reference signs, and detailed description thereof will be appropriately omitted.

Hereinafter, embodiments of the present invention will be described with reference to the drawings.

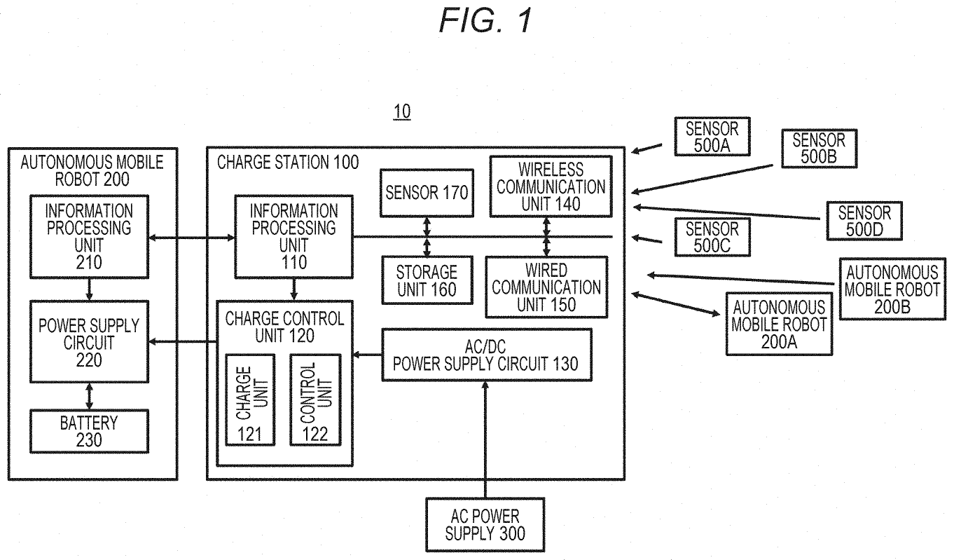

FIG. 1 is an overall system configuration diagram including a charge control system 10 that is an information processing system according to a first embodiment. Included are a charge station 100, a plurality of autonomous mobile robots (hereinafter, referred to as a robot) 200, 200A, 200B . . . each of which is an example of a mobile body, an alternating current (AC) power supply 300, and a plurality of sensors 500A, 500B, 500C, 500D . . . installed in an environment where the autonomous mobile robots move (travel, in this example). Although there is a plurality of robots in the example in FIG. 1, there may be one robot. Furthermore, although a plurality of sensors is installed in the environment where the robots move (travel environment), one sensor may be installed. Any one or more of the sensors 500A, 500B, 500C, 500D . . . will be referred to as a sensor 500X. Any one or more of the robots 200A, 200B, . . . will be referred to as a robot 200X.

The robots 200, 200A, 200B, and the like are mobile bodies that travel in an environment such as an office, a factory, or outdoors. The robots 200, 200A, 200B, and the like travel along a designated path from a departure point to a destination point by executing a task of moving along the designated path. The task may be simply a travel from the departure point to the destination point, or may include work such as loading or unloading of a carried object in middle of the traveling. The path for traveling from the departure point to the destination point can be determined by the charge station 100, can be determined by a robot itself on the basis of information of a map of the travel environment, or can be determined by an external operation management apparatus (not illustrated) that generates operation plans for a plurality of robots.

The robots 200, 200A, 200B, and the like are examples of mobile bodies. Other than a robot, the mobile body according to the present embodiment may be any mobile body such as an automatic guided vehicle (AGV), an automobile (an electric vehicle (EV), a plug-in hybrid vehicle (PHV), or the like), or a drone, as long as the mobile body uses power of a storage battery as a power source.

The robot 200 includes an information processing unit (processing unit) 210, a power supply circuit 220, and a storage battery 230. The other robots 200A, 200B, and the like have similar configuration.

The storage battery 230 is a chargeable/dischargeable battery that accumulates electric energy (electric power) for the robot 200 to move. The storage battery 230 may also be referred to as a secondary battery. Power accumulate in the storage battery 230 is supplied by the charge station 100.

The power supply circuit 220 charges and discharges the storage battery 230 under control of the charge station 100 coupled to the robot 200. The charging and discharging means at least one of charge or discharge. Power may be transmitted and received to and from the charge station 100 either by wire or wirelessly. In a case of wired connection, the robot and the charge station 100 are connected by a wired cable. In a case of wireless communication, a power signal is transmitted and received between the robot and the charge station 100, for example, via magnetic coupling between coils.

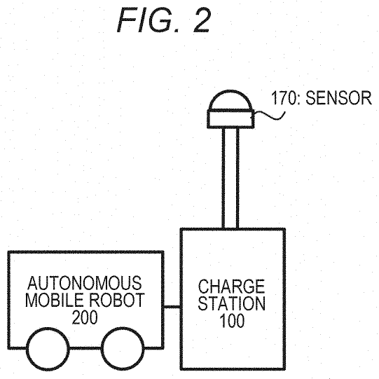

FIG. 2 is a view illustrating a state where the robot 200 is coupled to the charge station 100. The charge station 100 includes, as a sensor 170, a 360° camera that captures an image of a travel environment in a wide range.

The power supply circuit 220 is coupled to a mobile mechanism (such as a motor and wheels) of the robot and an information processing unit 210 via internal wiring. The power supply circuit 220 takes out, from the storage battery 230, power necessary for operation of the mobile mechanism and the information processing unit 210, and supplies the power to the mobile mechanism and the information processing unit 210. The power supply circuit 220 supplies power necessary for operation to a member operated by power, in addition to the mobile mechanism. For example, the storage battery 230 may supply power to a display unit (not illustrated) that displays data, a light emission unit (not illustrated) that displays an operation state, a storage unit (not illustrated) that stores data, or the like.

The power supply circuit 220 charges the storage battery 230 with power regenerated from the motor while the robot 200 is moving along a path having a downward gradient. The storage battery 230 tends to deteriorate quickly if maintaining a fully charged state or a state close to the fully charged state (hereinafter, full charge or the like). For this reason, the charge station 100 controls an amount of power (amount of charge) to be charged into the mobile body so that the storage battery 230 is not fully charged or the like by the storage battery 230 being charged with power regenerated while the robot 200 is traveling.

The information processing unit 210 performs various kinds of information processing necessary for operation of the robot 200. The information processing unit 210 can communicate with the charge station 100 by wire or wirelessly. The communication method may be any method such as wireless local area network (LAN), Bluetooth (registered trademark), 5G (fifth generation mobile communication system), long term evolution (LTE), a serial cable, Ethernet (registered trademark), or a dedicated communication method. The information processing unit 210 includes various processors such as a central processing unit (CPU) or a micro processing unit (MPU), a circuit such as an application specific integrated circuit (ASIC) or a field programmable gate array (FPGA), or a combination thereof. As an example, a function of the information processing unit 210 is executed by causing a program of a CPU or the like to execute the program. In this case, the program may be stored in a storage unit (not illustrated) in the robot 200.

The information processing unit 210 performs control to move the robot 200 to the destination point by acquiring task information that instructs to perform a task of moving from the departure point to the destination point, and executing a task indicated in the task information. The task information may be stored in advance in the storage unit (not illustrated) in the robot, may be provided from the charge station 100, may be provided from an operation planning apparatus (not illustrated) that generates operation plans for the plurality of robots, or the like.

The information processing unit 210 executes various kinds of processing necessary for executing charging with the charge station 100. For example, the information processing unit 210 executes a protocol before starting charging (determines a charge method or the like). Furthermore, the information processing unit 210 may acquire, from the charge station 100, information for identifying a charge state to be targeted (for example, State of Charge: SoC) of the storage battery 230. The information processing unit 210 may monitor the amount of power accumulated in the storage battery 230, and may notify the charge station 100 of information indicating that charge is completed in a case where the storage battery 230 is charged to the charge state to be targeted (target charge state).

The charge station 100 includes an information processing unit (processing unit) 110, a charge control unit 120, an AC/DC power supply circuit 130, a wireless communication unit 140, a wired communication unit 150, a storage unit 160, and the sensor 170. As an example, the charge station 100 includes an information processing apparatus according to the present embodiment. As an example, the information processing apparatus includes an information processing unit 110 and a control unit 122 (described later) of the charge control unit 120. The information processing apparatus may be provided in the robot 200. The AC/DC power supply circuit 130 is connected to the AC power supply 300. The AC power supply 300 may be a commercial power supply or may be a power supply apparatus including a direct current (DC) power supply and an inverter.

The AC/DC power supply circuit 130 converts AC power supplied from the AC power supply 300 into DC power. The AC/DC power supply circuit 130 supplies the converted DC power to the charge control unit 120 and other members operating with the power in the charge station 100. As an example, the other members include at least one of the information processing unit 110, a camera 170, the storage unit 160, the wireless communication unit 140, or the wired communication unit 150.

The sensor 170 is a sensor that senses a travel environment of the robots 200 and 200X. As an example, the sensor 170 is a luminance camera (such as an RGB camera), a ranging camera (a Time of Flight (ToF) camera, a stereo camera, or the like), or both thereof. As an example, the camera is a 360° camera. A sensor other than the camera, for example, a Lidar (light detection and ranging, or laser imaging detection and ranging), a millimeter wave radar, an ultrasonic sensor, or the like may be used together with, or in addition to, the camera. The number of sensors may be one or more.

The wireless communication unit 140 can wirelessly communicate with the sensor 500X disposed in the travel environment. As an example, the wireless communication unit 140 receives data detected by the sensor 500X. Furthermore, the wireless communication unit 140 can wirelessly communicate with another robot 200X traveling in the travel environment or waiting for departure. Furthermore, a wireless communication apparatus 140 can wirelessly communicate with the robot 200 charged from the charge station 100. The wireless communication unit 140 performs communication related to control of the robots 200 and 200X. The wireless communication unit 140 may receive data detected by sensors included in the robots 200 and 200X. The communication method may be any method such as wireless local area network (LAN), Bluetooth (registered trademark), 5G (fifth generation mobile communication system), long term evolution (LTE), or a dedicated communication method.

The wired communication unit 150 can communicate by wire with the sensor 500X disposed in the travel environment. As an example, the wired communication unit 150 receives data detected by the sensor 500X. Furthermore, the wired communication unit 150 can communicate by wire with the robot 200X traveling in the travel environment or waiting for departure. Furthermore, the wired communication unit 150 can communicate by wire with the robot 200 charged from the charge station 100. The wired communication unit 150 performs communication related to control of the robots 200 and 200X. Furthermore, the wired communication unit 150 may receive data detected by the sensors included in the robots 200 and 200X. The communication method may be any method such as a serial cable, Ethernet (registered trademark), or a dedicated communication method.

In a case where the sensor 500X and the robot 200X communicate only either wirelessly or by wire, the charge station 100 may include only either the wireless communication unit 140 or the wired communication unit 150.

The storage unit 160 stores data acquired by the sensor 170, data received by the wireless communication unit 140 from the sensor 500X and the robot 200X, and data received by the wired communication unit 150 from the sensor 500X and the robot 200X. In a case where the information processing unit 110 is a processor such as a CPU, the storage unit 160 may store a program to be executed by the processor. In addition, various data necessary for operation of the station may be stored. For example, map information indicating a travel environment may be stored in the storage unit 160. Parameter information (for example, camera parameter information) of the sensor 170 may be stored in the storage unit 160. The map information may be stored in the storage unit of the robot 200. The storage unit 160 is a storage medium such as a nonvolatile memory, volatile memory, hard disk, SSD, magnetic storage apparatus, or optical storage apparatus that temporarily or permanently stores data.

Under control of the information processing unit 110, the charge control unit 120 controls charging and discharging of the storage battery 230 of the robot by using the DC power supplied from the AC/DC power supply circuit 130. The charge control unit 120 includes a charge unit 121 and the control unit 122. Some of the functions of the charge control unit 120 (for example, a function of the control unit 122) may be provided in the robot 200.

The charge unit 121 is connected by wire or wirelessly to the power supply circuit 220 of the robot 200 to be charged, and supplies power for charging. The power to be supplied can be either DC or AC. In a case of supplying AC power, the charge unit 121 converts DC power supplied from the AC/DC power supply circuit 130 into AC. In this case, the robot 200 that receives the power converts the supplied AC power into DC and charges the storage battery 230.

In a case where the robot 200 moves along a path from the departure point to the destination point, the control unit 122 acquires environment information (travel environment information) of the path from at least one of the sensor 500X, the robots 200 and 200X, or the sensor 170X, at least after start of charge of the robot 200 or after a charge start instruction from the information processing unit 110. An amount of power to be charged in the storage battery 230 is controlled on the basis of the acquired travel environment information. Specifically, as an example, the control unit 122 acquires charge instruction information including information for identifying the charge state to be targeted (target charge state) of charge from the information processing unit 110. The control unit 122 controls the charge unit 121 to perform charging up to the target charge state identified by the instruction information. The control unit 122 acquires the instruction information at least after the start of the charge or after the charge start instruction from the information processing unit 110, and changes (updates) the target charge state every time instruction information is received from the information processing unit 110. A change of the target charge state includes both a case where the target charge state becomes larger than a previous instruction, and a case where the target charge state becomes smaller than a previous instruction. An initial target charge state may be determined in advance, or may be acquired from the information processing unit 110 before the start of the charge. The control unit 122 stops charging in a case where the charge is performed up to a target power state. The control unit 122 may stop the charging in a case of having received a notification from the robot 200 that the charge is completed. Although there is assumed a case where the travel environment information is acquired after the start of the charge of the robot 200 In the following description, the travel environment information may be acquired after the charge start instruction from the information processing unit 110.

Information for identifying the target charge state may be information designating a value of the target charge state. For example, in a case where a fully charged state is set to 100% and charge is to be performed up to 70%, 70% is designated as the target charge state. Alternatively, the information for identifying the target charge state may be information designating a value of an amount of power (target amount of power) necessary for charging the storage battery 230 up to the target charge state. For example, the control unit 122 may calculate the target amount of power on the basis of a difference between the charge state before the start of the charge of the storage battery 230 and the target charge state, and on the basis of the battery capacity of the storage battery 230. The control unit 122 controls the charge unit 121 to perform charging up to the target amount of power. The control unit 122 may acquire the charge state before the start of charge from the storage battery 230, may calculate, from a past travel history (movement history data) of the storage battery 230, the charge state before the start of the charge, or may acquire the charge state before the start of the charge with another method.

The information processing unit (processing unit) 110 performs various kinds of information processing in the charge station 100. The information processing unit 110 includes various processors such as a central processing unit (CPU) or a micro processing unit (MPU), a circuit such as an application specific integrated circuit (ASIC) or a field programmable gate array (FPGA), or a combination thereof. As an example, a function of the information processing unit 110 is executed by causing a program of a CPU or the like to execute the program. In this case, the program may be stored in the storage unit 160. Some functions of the information processing unit 110 may be mounted on the information processing unit 110 of the robot.

As an example, the information processing unit 110 executes various kinds of processing necessary for executing charging with the robot 200 to be charged. For example, the information processing unit 110 executes a protocol before starting charging (determines a charge method or the like). Furthermore, the information processing unit 110 determines a target charge state (target charge state) of the storage battery 230 of the robot 200, and generates charge instruction information including information for identifying the target charge state. Alternatively, the information for identifying the target charge state may be information designating the target charge state, or information designating a value of an amount of power necessary for charging the storage battery 230 up to the target charge state. The information processing unit 110 provides the generated charge instruction information to the charge control unit 120. That is, a charge start instruction is issued to the charge control unit 120. The information processing unit 110 may provide the robot 200 with information for identifying the target charge state. In a case where information indicating completion of charge up to the target charge state is received from the robot 200, the information processing unit 110 may provide the information to the charge control unit 120.

The information processing unit 110 acquires, from at least one of the sensor 500X, the robots 200 and 200X, or the sensor 170, information (travel environment information) indicating a travel environment of a path along which the robot 200 to be charged is scheduled to travel after at least after the start of the charge. The information processing unit 110 determines a target charge state of the robot 200 on the basis of the acquired travel environment information.

As an example, the information processing unit 110 may estimate an amount of regenerative power generated by the robot 200 to be charged traveling, and determine a target charge state on the basis of the estimated regenerative power amount and the travel environment information. That is, the control unit 122 may control the amount of power to be charged into the storage battery 230 on the basis of the regenerative power amount estimated by the information processing unit 110 and the travel environment information.

The information processing unit 110 may determine the target charge state on the basis of weight of the robot 200 to be charged. That is, the control unit 122 may control the amount of power to be charged into the storage battery 230 on the basis of the weight estimated by the information processing unit 110. The weight may not an actual weight, but may be a class categorized as heavy, standard, light, or the like.

The information processing unit 110 may determine the target charge state on the basis of a disposition status of an obstacle on the path along which the robot 200 to be charged travels. That is, on the basis of the disposition status of the obstacle on the path, the control unit 122 may control the amount of power to be charged into the storage battery 230. The disposition status of the obstacle is based on at least any one of presence or absence of an obstacle, a size of an obstacle, an installation area of the obstacle, disposition density of the obstacles, and the number of the obstacles. Specific examples of the obstacle include a load, another robot, a worker, and the like.

The information processing unit 110 may determine the target charge state on the basis of a road surface condition of the path along which the robot 200 to be charged travels. That is, on the basis of the road surface condition of the path, the control unit 122 may control the amount of power to be charged into the storage battery 230. As an example, the road surface condition is based on at least either a wet-dry condition of a road surface (wet, dry, frozen, or the like) or a material of the road surface (gravel road, asphalt, or the like).

The information processing unit 110 may determine the target charge state on the basis of a weather condition of the path along which the robot 200 to be charged travels. That is, on the basis of the weather condition of the path, the control unit 122 may control the amount of power to be charged into the storage battery 230. Examples of the weather condition include weather, wind speed, wind direction, temperature, humidity, and the like. Examples of a sensor that detects the weather condition include various sensors such as a raindrop sensor, a fog sensor, a sunshine sensor, a snow sensor, and an illuminance sensor.

The information processing unit 110 may select a path along which the robot 200 to be charged travels from among a plurality of paths (path candidates) and provide the robot 200 with information instructing the selected path. In this case, the information processing unit 110 determines the target charge state in a case where the robot 200 travels along the selected path. Processing in which the information processing unit 110 selects a path will be described in detail in a second embodiment or a third embodiment. Hereinafter, there is assumed a case where the robot 200 travels along an arbitrary path selected by the information processing unit 110 or an arbitrary path selected by the robot 200 by itself.

Hereinafter, the information processing unit 110 will describe in detail processing of controlling, on the basis of the travel environment information acquired from at least one of the sensor 500X, the robot 200X, or the like, the amount of power to be charged into the storage battery 230 of the robot 200 (for example, processing of determining the target charge state of the storage battery 230 of the robot).

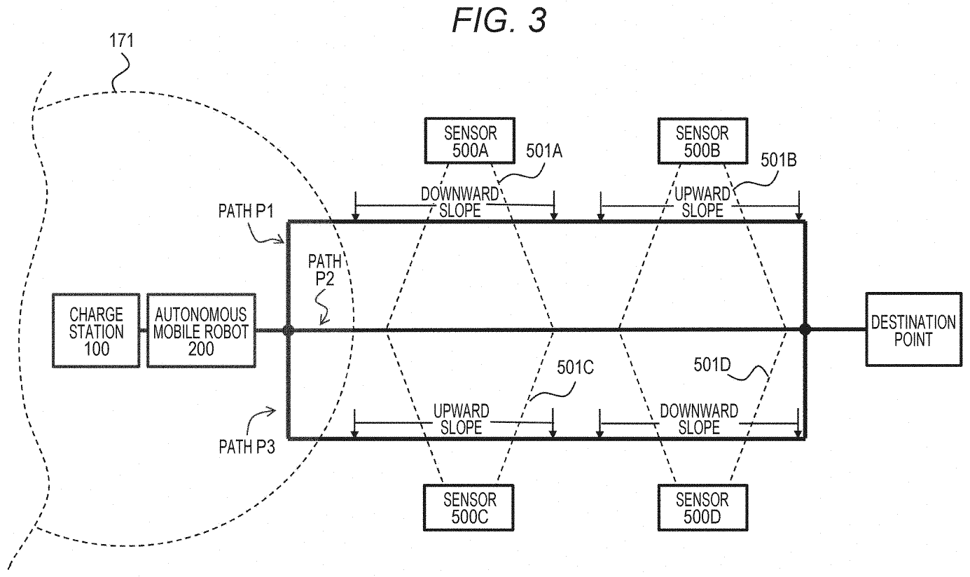

FIG. 3 schematically illustrates a plurality of paths P1, P2, and P3 in the travel environment, and a situation in which the robot 200 is connected to the charge station 100 and charged from the charge station 100. A position at which the robot 200 is charged from the charge station 100 is the departure point of the robot 200. There is assumed a case where the robot 200 moves along the path P1 from the departure point to the destination point. The path P1 is a path arbitrarily selected from among the plurality of paths P1, P2, and P3 that can reach the destination point. The paths P1 to P3 include at least one of an upward gradient road surface (upward slope), a downward gradient road surface (downward slope), or a flat road surface. In the path P1, there is a downward slope on the way, and then, via a flat road, there is an upward slope. In the path P2, an entire road surface is flat. In the path P3, there is an upward slope on the way, and then, via a flat road, there is a downward slope. Information regarding gradients (inclinations) in the paths P1 to P3 is provided in advance as part of path information of map information indicating a travel environment. That is, for each path, information such as how much the road surface is inclined and how long the gradient is included in the map information.

Here, the sensor 170 of the charge station 100 is a 360° camera, and an imaging area (sensing area) 171 of the camera is illustrated. Furthermore, a plurality of sensors 500A to 500D installed in the travel environment is cameras here, and imaging areas 501A to 501D of the sensors 500A to 500D are illustrated. Although only the robot 200 to be charged is illustrated in the drawing, there may be another robot traveling along at least any one of the paths P1 to P3 or along another path (not illustrated). Note that each of the paths P1 to P3 or the like may have a width that allows two or more robots to travel in opposite directions (pass each other). In a case of a path having a width in which two or more robots cannot pass each other at the same time, control for preventing a deadlock may be performed in which, for example, one robot waits for another robot passing through the path at an intersection of the paths. The control may be performed by autonomous control by the robots, or may be performed by an operation management apparatus (not illustrated) that manages operation of each of the robots. The control may be performed by the information processing unit 110 of the charge station 100.

After the start of the charge, on the basis of the travel environment information acquired from the sensor 170 of the charge station 100, a camera 500X in the travel environment, or the like, the charge control unit 120 of the charge station 100 controls the amount of power (amount of charge) charged into the robot 200 to be charged. Specifically, for example, the information processing unit 110 acquires the travel environment information at regular time intervals, and determines a target charge state of the robot 200 on the basis of the acquired travel environment information. That is, the target charge state of the robot 200 is determined in real time on the basis of the travel environment. The charge station 100 determines the target charge state so that the storage battery 230 is not fully charged or brought into a state close to full charge (full charge or the like) due to charging of regenerative power while the robot 200 is traveling, and that the robot 200 does not run out of electricity during traveling. The storage battery 230 is prevented from being fully charged or the like, because the storage battery 230 tends to deteriorate quickly if remaining fully charged or the like. The charge control unit 120 of the charge station 100 controls charge of the robot 200 until the storage battery 230 is charged up to the determined target charge state. After the charge is completed, the robot 200 disconnects from the charge station 100 and departs for the destination point.

Hereinafter, a specific example in which the charge station 100 determines the target charge state will be described.

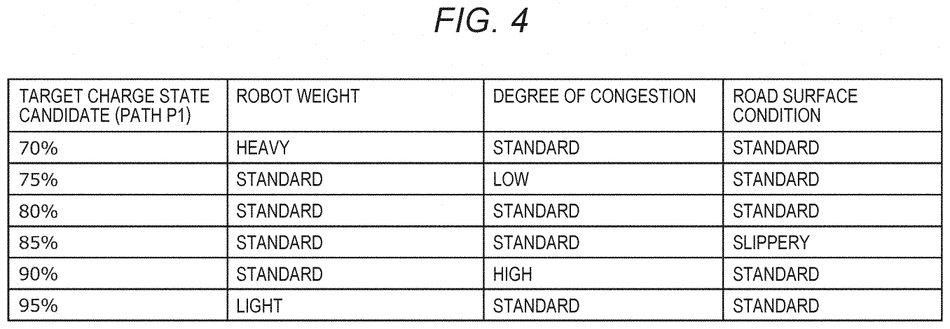

FIG. 4 illustrates an example of a charge control table used for determining a target charge state. The charge control table is provided for each path connecting the departure point and the destination point. The charge control table includes items, Target charge state candidate, Robot weight, Degree of congestion (disposition status of obstacle), and Road surface condition. In the example in the drawing, an example of the charge control table for the path P1 selected in FIG. 2 is illustrated.

The target charge state candidate is a candidate for a target charge state to be applied to the robot 200 to be charged.

The robot weight indicates a weight of the robot itself, or a weight obtained by summing the weight of the robot itself and a weight of a load (load weight) mounted on the robot. Instead of the robot weight, the load weight of the robot may be used. The robot weight is represented by a class “Standard”, “Heavy”, or “Light”. For example, assuming a standard weight, −19% to 19% or less of the standard weight may be “Standard”, 20% or more of the standard weight may be “Heavy”, and −20% or less of the standard weight may be “Light”. As another example, the robot weight may be represented by a weight value range (for example, 30 kilograms or less, 31 to 40 kilograms, 41 kilograms or more, or the like). The robot weight may be provided in advance by a method such as being included in task information or specification information, or a worker may input information of the robot weight by using an input terminal so that the input information is provided to the charge station 100 by wired or wireless communication.

The degree of congestion indicates how many obstacles are disposed on the path (here, the path P1). The degree of congestion can be determined on the basis of, for example, at least any one of an installation area of the obstacle, disposition density of the obstacles, or the number of the obstacles.

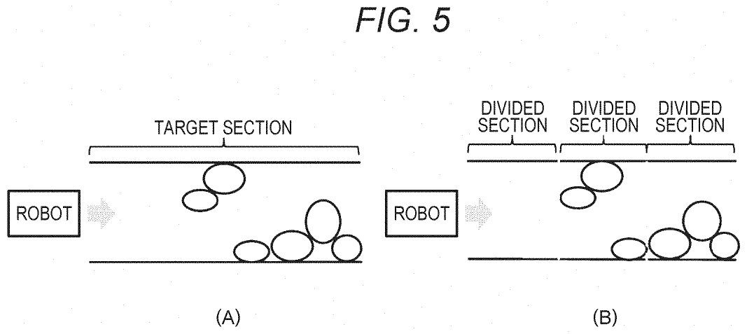

FIGS. 5(A) and 5(B) illustrate an example of calculating a degree of congestion. In FIG. 5(A), the degree of congestion is calculated on the basis of an area of obstacles disposed in a specific section (target section) of the path. As an example, the larger the area, the higher the degree of congestion. Alternatively, the degree of congestion is calculated on the basis of a proportion of the area occupied by the obstacles in a total area of the specific section of the path. The higher the proportion, the higher the degree of congestion. For example, the degree of congestion can be represented by classes “Standard”, “High”, or “Low” according to a proportion value range. Specifically, a standard proportion (or area) is assumed, and −19% to 19% or less of the standard proportion may be “Standard”, 20% or more of the standard proportion may be “High”, and −20% or less of the standard proportion may be “Low”. As another example, the degree of congestion may be represented by a proportion value range (or area). The specific section may be an entire section of the path or may be a section where an obstacle is likely to be placed.

In FIG. 5 (B), the specific section of the path is divided into a plurality of sections (divided sections). Widths of the respective divided sections may be the same or different. A proportion of an area of the obstacles in an area of a divided section is calculated for each divided section. A degree of congestion is calculated on the basis of a statistical value (maximum value, average value, median value, minimum value, or the like) of the calculated proportion. For example, there may be set three value ranges that are “Low” for when the maximum value belongs to a smallest range, “High” for when the maximum value belongs to a largest range, and “Standard” for when the maximum value belongs to an intermediate range.

Although the area of the obstacle or the proportion of the area of the obstacle in the area of the path is used in the examples in FIGS. 5(A) and 5(B), the degree of congestion may be determined on the basis of the number of obstacles, presence or absence of an obstacle, or a size of an obstacle.

The road surface condition indicates whether or not a road surface of the path is slippery (that is, whether or not the wheels or the like of the robot tend to spin). For example, the road surface is slippery if wet or frozen, and is less slippery if dry. Furthermore, the road surface is slippery in a case where a material thereof is gravel road or the like, and is less slippery in a case where the material thereof is asphalt or the like. Similarly to a case of the degree of congestion, the road surface condition can be determined on the basis of an area of a slippery road surface in the specific section or a proportion of an area of a slippery road surface in the specific section. As an example, the road surface condition is determined to be “Slippery” in a case where the area or proportion is equal to a constant value or more, and “Standard” in a case where the area or the proportion is less than the constant value. Although two classes are exemplified, three classes “Slippery”, “Standard”, and “Less slippery” may be used, or a class “Very slippery” may be added. The road surface condition may be defined by another method. The road surface condition may be identified by performing image recognition (for example, semantic segmentation) on image data captured by a camera, or may be identified by using a visible-light sensor or invisible-light sensor and a light source. Alternatively, slipperiness may be estimated on the basis of a state of the spinning of the wheels or the like when another robot 200X moves along the path (here, the path P1). For example, by using odometry, the number of times of spins may be calculated from a distance the robot 200X has moved and a rotation rate of the wheels. In a case where the number of times of spins is a constant value or more, it may be judged that the road surface is slippery.

The information processing unit 110 identifies a target charge state candidate corresponding to a set of Robot weight, Degree of congestion, and Road surface condition in the charge control table in FIG. 4, and determines the identified candidate as a target charge state. For example, if the robot weight is “Heavy”, the degree of congestion is “Standard”, and the road surface condition is “Standard”, 70% is determined as the target charge state. Furthermore, if “Standard” applies to all the three items, 80% is determined as the target charge state.

The target charge state in a case where “Standard” applies to all the three items is referred to as a standard charge state. As an example, the standard charge state is determined on the basis of a standard regenerative power amount calculated from a height difference (for example, a gradient and a distance) of a downward gradient part among the plurality of parts obtained by dividing the path P1. As an example, a total regeneration amount obtained by summing estimated regenerative power amounts obtained at the downward gradient parts of the path P1 is calculated. Furthermore, for example, amounts of power consumed by traveling to the destination point are calculated for an upward gradient part and a flat part, and are summed to calculate a total power consumption. In a case where there is power consumed by traveling also at the downward gradient part, the amount of power is added to calculate the total power consumption. In calculation of the total power consumption, it may be assumed that the robot moves at a standard speed. Furthermore, a value of power consumption corresponding to a gradient may be determined. In a case where the robot performs operation of loading or unloading a load on the way, power consumed by the operation may be included. On the basis of the total power consumption and the total regeneration amount, a charge state at a time of departure may be determined such that a charge state at a time of arrival at the destination point falls within a certain range of a desired charge state. The desired charge state can be arbitrarily determined, for example, by setting a value thereof by adding a margin to a lower limit charge state allowed for the storage battery 230.

As can be understood from the charge control table in FIG. 4, the heavier the robot weight, the smaller the value of the target charge state. This is because the regenerative power amount at the downward gradient part increases if the robot weight is heavy. Note that, in a case where an entire path is an upward gradient, power regeneration cannot be expected, and thus the value of the target charge state tends to increase as the robot weight increases. Furthermore, the higher the degree of congestion, the larger the value of the target charge state. If the degree of congestion is high, the number of obstacles to be avoided increases, and thus power consumption tends to increase for avoidance actions. Furthermore, in a case where the road surface condition is slippery, the value of the target charge state tends to be large. This is because in a case where the road surface is slippery, the wheels and the like spin, and therefore the power consumption amount increases. Thus, the robot weight, the degree of congestion, and the road surface condition function as parameters for correcting a value of the standard charge state (80% in this example).

The charge control table in FIG. 4 is stored in the storage unit 160 in advance. The values of the respective items in the charge control table are set in advance. Because content of the charge control table varies depending on a travel environment to which the present embodiment is applied, it is conceivable to set different values depending on the travel environment to which the present system is applied. Furthermore, after starting operation of the charge control system 10, the information processing unit 110 may update values of Target charge state candidate in the charge control table by using machine learning. For example, by using a regression model method of a neural network or the like, the values of the target charge state candidate may be optimized so that a difference between a charge state when the robot arrives at the destination point and the desired charge state is small.

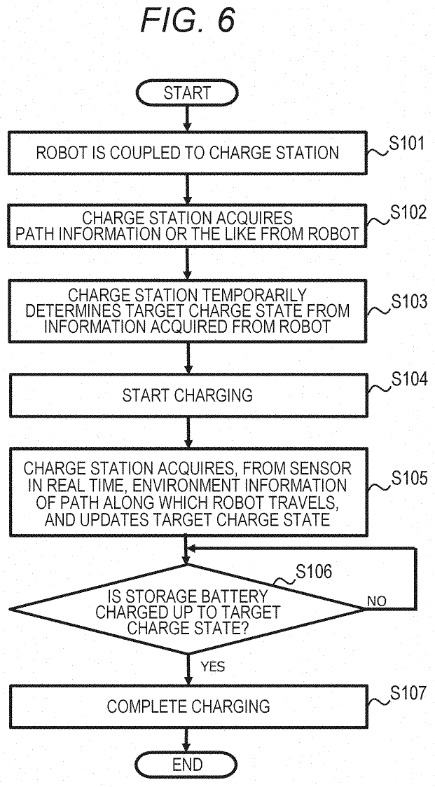

FIG. 6 is a flowchart of an example of operation of the charge control system 10 according to the first embodiment. The robot 200 is coupled to charge station 100 (S101). The coupling may be wired or wireless.

The information processing unit 110 of the charge station 100 acquires, from the robot 200, information of a path along which the robot 200 travels (path information) (S102). In addition to the path information, information such as past travel history information of the robot and specification information of the robot may be acquired.

The information processing unit 110 of the charge station 100 determines a target charge state of the robot 200 on the basis of the path information of the robot 200 (S103). As an example, a standard charge state associated with the path in advance is temporarily determined as the target charge state. At this time, the target charge state may be temporarily determined further on the basis of the robot weight (the weight of the robot itself, or a weight obtained by adding the weight of the robot and the load weight of the robot), or a weight of a load mounted on the robot (refer to the charge control table in FIG. 4). The target charge state may be determined by using the travel history information (movement history data). For example, in a case where the charge state at a time of arrival at the destination point in past tends to be equal to or higher than the desired charge state by the constant value, the target charge state determined from the path information may be corrected by subtracting the constant value. The information processing unit 110 provides the charge control unit 120 with charge instruction information including information for identifying the target charge state. Alternatively, the information for identifying the target charge state may be information designating the value of the target charge state, or may be information designating a value of an amount of power (target amount of power) necessary for charging the storage battery 230 up to the target charge state.

The control unit 122 of the charge control unit 120 controls the charge unit 121 according to the instruction information, thereby starting the charge of the storage battery 230 mounted on the robot 200 (Same Step S104).

After the charge of the robot 200 is started, the information processing unit 110 of the charge station 100 acquires travel environment information from at least one of the sensor 170, the sensor 500X, or sensors of the robots 200 and 200X, and identifies a travel environment of the path along with the robot 200 travels (S105). For example, the degree of congestion, the road surface condition, or the like of the path along with the robot 200 travels is identified. The information processing unit 110 updates the target charge state of the robot 200 on the basis of the identified travel environment, the charge control table in FIG. 4, or the like (Same Step S105). The information processing unit 110 provides the charge control unit 120 with charge instruction information including information for identifying the updated target charge state. In a case where the target charge state is not changed by the update, provision of the instruction information may be omitted. The control unit 122 of the charge control unit 120 controls the charge unit 121 according to instruction information instructing the updated target charge state.

As an example, in a case where it suddenly rains after the start of the charge and a puddle is formed in a specific section of the path, it is conceivable that the road surface is judged to be slippery, and that the target charge state is changed to a larger value. Furthermore, in a case where it is detected after the start of the charge that obstacles more than the standard number are disposed on the path, it is conceivable that the target charge state is changed to a larger value. Meanwhile, in a case where it is detected after the start of the charge that the number of the obstacles disposed on the path is less than the standard number, it is conceivable that the target charge state is updated to a smaller value.

The information processing unit 110 or the charge control unit 120 judges whether or not the charge up to the target charge state is completed (S106), and in a case where the charge is not completed, the processing returns to Step S105. In a case where the charge up to the target charge state is completed, the present processing ends (S107). Note that, in a case where, as a result of updating the target charge state, the target charge state becomes smaller and the amount of the power accumulated in the storage battery 230 exceeds the updated target charge state, the storage battery 230 may perform discharge. After the charge (or discharge) is completed, the robot 200 is decoupled from the charge station 100, departs according to the path information at a departure time, and moves toward the destination point.

Although the target charge state is temporarily determined without using the travel environment information before the start of the charge in the processing in FIG. 6, the travel environment information may be acquired also before the start of the charge, and a target charge state may be determined by using the acquired travel environment information. With this arrangement, it is possible to reduce possibility that the target charge state greatly fluctuates after the start of the charge.

As described above, according to the present embodiment, a target charge state is determined by using an amount of regenerative power generated in a path along which the robot travels and travel environment information of after start of charge, and the charge is performed up to the target charge state (that is, a storage battery is not fully charged, and an amount of power charged in the storage battery is limited). With this arrangement, it is possible to prevent the storage battery 230 from being fully charged or nearly fully charged while the robot is traveling, and to retard progress of deterioration of the storage battery 230. Furthermore, because it is not necessary to fully charge or the like the storage battery 230 at a time of departure, charging time can be shortened. Furthermore, full charge or the like is suppressed even if the storage battery 230 is charged with regenerated power, and thus, the robot 200 does not need to be equipped with a load resistance apparatus for consuming excess regenerative power that cannot be charged into the storage battery 230.

[Modification]

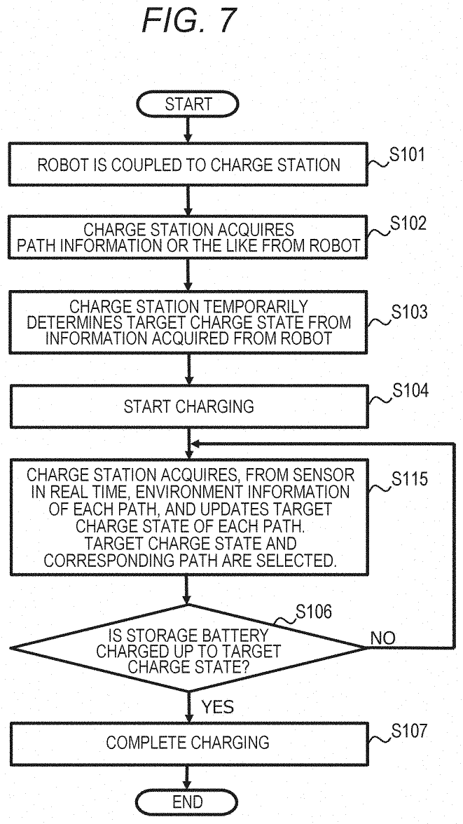

FIG. 7 illustrates a modification of the charge control system according to the first embodiment. In the charge control system in FIG. 1, the AC power supply 300 is used as a power source of the charge control system, while a DC power supply 301 is used in FIG. 7. Furthermore, a DC/DC power supply circuit 131 is used instead of the AC/DC power supply circuit 130 in FIG. 1. The DC/DC power supply circuit 131 is connected to the DC power supply 301. As the DC power supply 301, for example, a power storage apparatus or a battery can be used. The DC/DC power supply circuit 131 performs DC/DC conversion on DC voltage supplied from the DC power supply 301 according to voltage of a battery 230 as a supply destination. The charge control unit 120 charges the robot 200 by using the converted DC voltage.

### Second Embodiment

From among a plurality of paths that can reach a destination point from a departure point of a robot, an information processing unit 110 of a charge station 100 selects a path along which the robot travels, on the basis of an amount of regenerative power generated in each of the paths and travel environment information of each of the paths. For example, target charge states are calculated on the basis of the amount of the regenerative power generated in each of the paths and the travel environment information of each of the paths, and a path having a lowest target charge state or having a target charge state less than a threshold value is selected.

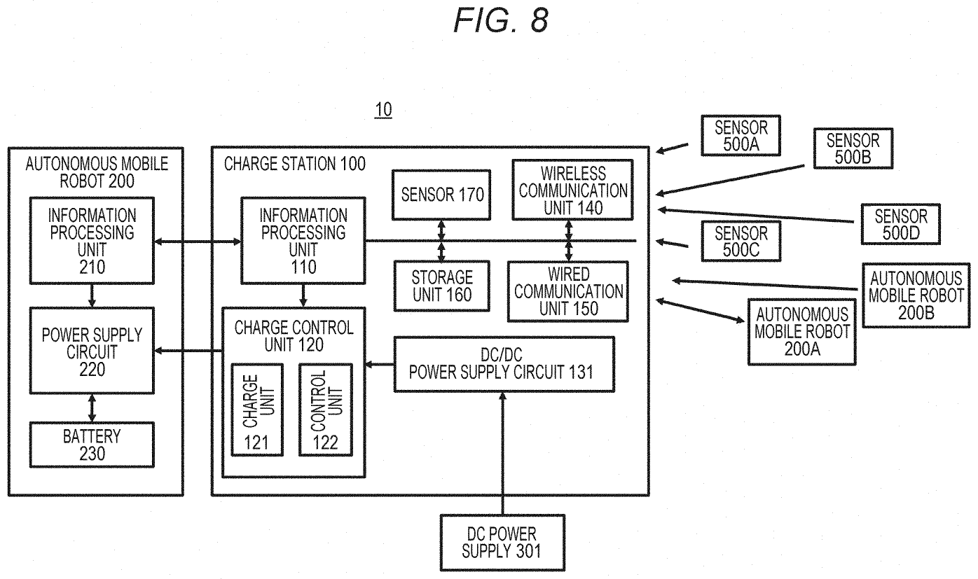

FIG. 8 is a flowchart of an example of operation of a charge control system 10 according to a second embodiment. Steps S101 to S104 are the same as Steps S101 to S104 in FIG. 6 in the first embodiment. In Step S115 subsequent to Step S104, the information processing unit 110 of the charge station 100 calculates the target charge state of each of the paths. A path having the lowest target charge state or having a target charge state less than the threshold value is temporarily selected. It is judged whether or not the storage battery 230 is charged up to the target charge state (S106), and Step S115 is repeatedly executed until the storage battery is charged up to the target charge state. If it is judged in Step S106 that the storage battery 230 is charged up to the target charge state, the path temporarily selected at this time is determined as the path along which a robot 200 will travel. By selecting a path having a low target charge state on the basis of real-time travel environment information in this manner, an amount of power charged in the storage battery 230 can be reduced, and therefore a battery with a small capacity can be used.

Processing in the present embodiment can also be performed by an information processing unit 210 of a robot, instead of the information processing unit 110 of the charge station 100.

### Third Embodiment

In the present embodiment, on the basis of presence of an obstacle or the like, an information processing unit 110 of a charge station 100 predicts whether or not a plurality of paths along which a robot 200 can reach a destination point from a departure point is passable. The information processing unit 110 calculates a target charge states of a path predicted to be passable, and, on the basis of the calculated target charge states, determines a path along which the robot 200 travels. Specifically, processing of predicting whether or not each path is passable is added to Step S115 in the flowchart (FIG. 8) of the second embodiment. On the path predicted to be passable, calculation of the target charge state and temporary selection of a path performed in Step S115 of the second embodiment are performed.

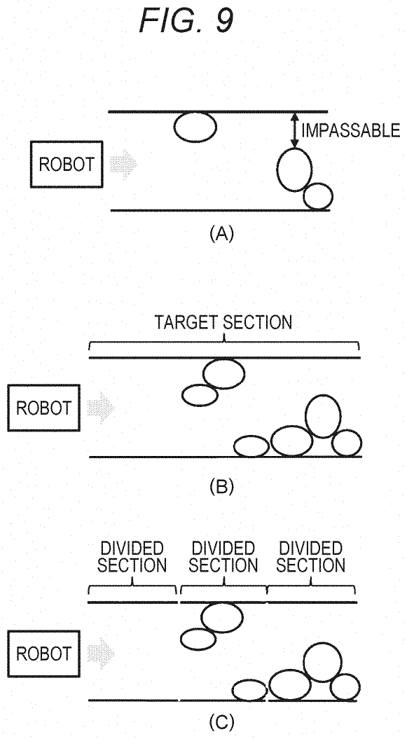

FIG. 9 is a diagram illustrating specific examples of judging whether or not a path is passable.

FIG. 9(A) illustrates an example in which a path is judged to be impassable in a case where there is an obstacle placed on the path, blocking passage, that is, in a case where a passable width is less than a constant value due to the obstacle. The constant value may be determined for each type of robot, or may be a value common to all robots. As an example, whether or not an obstacle is placed can be determined by comparison with a camera image of the path when no obstacle is placed, for example. Alternatively, the judgment may be made by performing image recognition with semantic segmentation or the like.

FIG. 9(B) illustrates an example in which a path is judged to be impassable in a case where a proportion of a total area of obstacles in an area of a specific section (target section) of a route is equal to or more than a constant value. This is because in a case where the proportion is equal to or more than the constant value, the robot may bypass the obstacles more frequently, and power consumption may be excessively increased. Alternatively, this is because there is a high possibility that an obstacle will be additionally disposed in future, and therefore the robot may not be able to pass. The specific section may be an entire section of the path or a part of the path.

FIG. 9(C) illustrates an example in which, for a plurality of sections (divided sections) obtained by dividing a specific section of a path, a proportion of a total area of obstacles, which is placed on each of the divided sections, in an area of a divided section is calculated, and whether or not the path is passable is judged on the basis of the proportion for each of the divided sections. For example, statistical values (maximum value, average value, median value, minimum value, or the like) of the proportions calculated for the plurality of divided sections are calculated, and the path is judged to be impassable in a case where there is a section of which the statistical value is equal to or more than a constant value. This is because in a case where the statistical value is equal to or more than the constant value, the robot 200 may bypass the obstacles more frequently, and power consumption may be excessively increased. Alternatively, this is because there is a high possibility that an obstacle will be additionally disposed in future, and therefore the robot 200 may not be able to pass.

In addition to the methods described with reference to FIG. 9, whether or not a path is passable may be judged on the basis of the number of the obstacles on the path, presence or absence of an obstacle on the path, or a size of an obstacle.

By excluding a path, which is judged by a method described in FIG. 9 to be impassable, from selection targets, it is possible to reduce possibility of selecting a path through which the robot cannot actually pass.

On the basis of information regarding an obstacle disposed on a path, the information processing unit 110 of the charge station 100 may judge possibility of the obstacle being moved (removed). That is, judgement is made on a possibility of a state of the path changing from a state where the robot 200 cannot pass to a state where the robot 200 can pass by the obstacle being removed from the path. In a case where it is judged that the obstacle is likely to be removed, the path is included in candidates to be selected as a path along which the robot 200 can travel.

Here, the information regarding the obstacle includes at least one item among a deformation status of a box as the obstacle, a speed of carrying the obstacle when the obstacle is carried to a position where the obstacle is disposed, whether or not there is a worker around the obstacle, a size of the obstacle, a deformation status of a floor on which the obstacle is disposed, and a weight of the obstacle.

As an example, in a case where an obstacle in an office or the like is heavy, it is conceivable that it is judged that the obstacle is less likely to be moved (the obstacle is difficult to carry, and therefore is likely not to be moved soon). As another example, in a case where there is a worker around the obstacle, it can be expected that the worker who has noticed the robot 200 moves the obstacle. In a case where weight of the obstacle is not known when judging whether or not the obstacle is heavy as described above, it may be estimated whether or not the obstacle is heavy or light. For example, in a case where the box as the obstacle is deformed, specifically, in a case where a side of a cardboard box is not straight, it is considered that the cardboard box is deformed at the time of carrying the obstacle due to the weight of the obstacle, and it can be estimated that the obstacle is heavy.

Furthermore, in a case where the floor on which the obstacle is disposed is deformed (for example, in a case where the obstacle sinks by a certain width or more), it can be estimated that the obstacle is heavy. The deformation status of the floor can be judged, for example, by comparison with a past camera image.

Furthermore, in a case where speed of carrying the obstacle to a current disposed position is slow, it can be estimated that the obstacle is heavy. As an example, the carrying speed can be estimated from image data from a camera that has captured an image of the obstacle.

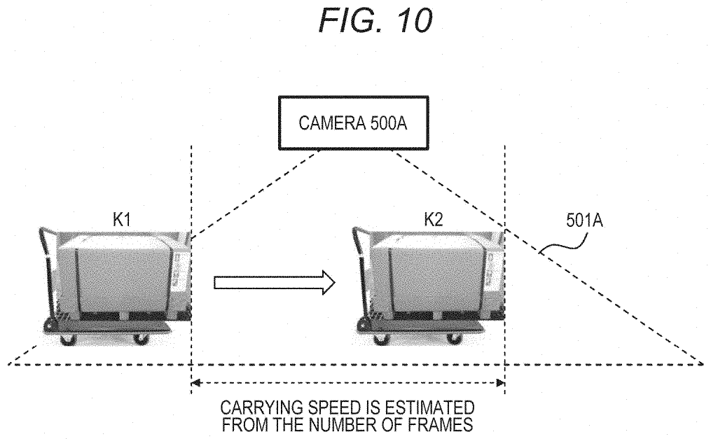

FIG. 10 illustrates an example of estimating a carrying speed. There are identified an image of when an obstacle to be carried enters an imaging area 501A of a sensor (camera) 500A (the image is described as an image 1 for convenience), and an image of the obstacle that is disposed (image of the obstacle that is stopped or immediately before stopping) (the image is described as an image 2 for convenience). In the example in the drawing, the obstacle is present at a position K1 in the image 1 when the obstacle enters the imaging area, and is present at a position K2 in the image 2 when the obstacle is disposed. The number of frames from the image 1 to the image 2 captured by the camera 500A is identified. A speed of carrying the obstacle can be calculated from the identified number of frames and unit time of the frames.

Thus, the possibility that the obstacle is moved (removed) from the path is comprehensively judged by using the information regarding the obstacle, and in a case where the obstacle is likely to be moved, it can be judged the path is a path along which the robot can travel (the path is passable). The robot may be moved before or after arriving at a position of the obstacle. In the latter case, it may be estimated whether or not the obstacle can be moved within a threshold period from arrival.

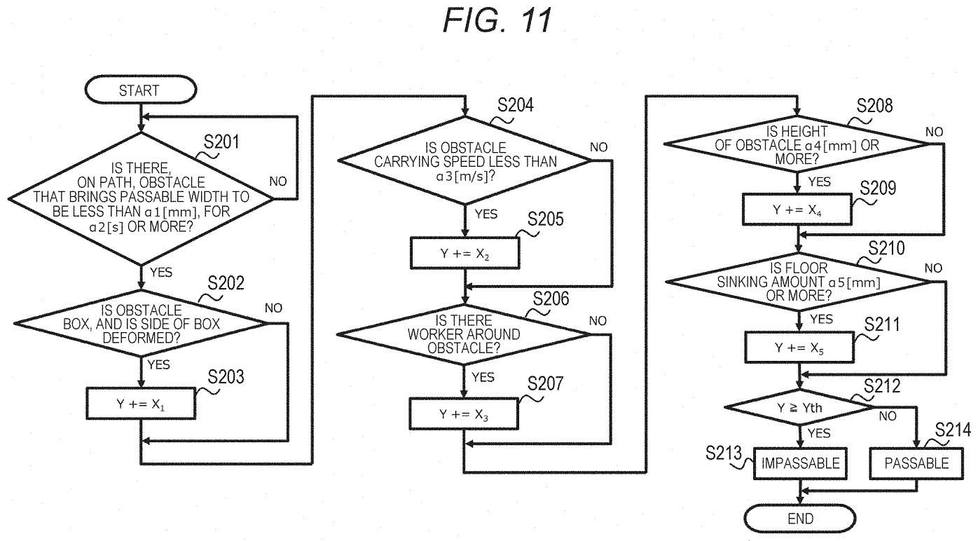

FIG. 11 is a flowchart of an example of processing of judging whether or not a target path is a path through which the robot 200 can pass.

It is judged whether or not there is an obstacle that blocks a passage along the path, for example, an obstacle that brings a width of a passable space on the path to be less than α1 (α1 is a real number) [mm], for α2 (α2 is a real number) seconds or more (S201).

In a case where there is an obstacle for α2 seconds or more, next, it is judged whether or not the box as the obstacle is deformed (S202). In a case where the box is deformed, a value X₁ is added to a parameter Y representing an evaluation value (S203). In a case where the box is not deformed, the value X₁ is not added. Whether or not the box as the obstacle is deformed may be judged by using, for example, a neural network that determines presence or absence of deformation.

Next, it is judged whether or not a carrying speed at which the obstacle is carried is less than α3 (α3 is a real number) [m/s] (S204). When the carrying speed is less than α3 [m/s], a value X₂ is added to the parameter Y (S205). When the carrying speed is α3 [m/s] or more, the value X₂ is not added.

Next, it is judged whether or not there is a worker around the obstacle (for example, within a predetermined distance) (S206). In a case where there is no worker, a value X₃ is added to the parameter Y (S207). In a case where there is a worker, the value X₃ is not added.

Next, it is judged whether or not height of the obstacle is α4 (α4 is a real number) [mm] or more (S208). In a case where the height is α4 [mm] or more, a value X4 is added to the parameter Y (S209). In a case where the height is less than α4 [mm], the value X4 is not added.

Next, it is judged whether or not an amount the floor sinks is α5 (α5 is a real number) [mm] or more (S210). In a case where the amount is α5 mm or more, a value X5 is added to the parameter Y (S211). In a case where the amount is less than α5 [mm], the value X5 is not added.

It is judged whether or not the parameter Y is equal to or greater than a threshold value Yth (S212), and in a case where the parameter Y is equal to or greater than the threshold value, it is determined that the path is impassable (S213). That is, it is judged that the obstacle is less likely to be removed before the robot 200 arrives at a position of the obstacle or within a threshold period after the arrival. In a case where the parameter Y is less than the threshold value, it is determined that the path is passable (S214). That is, it is judged that the obstacle is likely to be removed before the robot 200 arrives at a position of the obstacle or within a threshold period after the arrival.

The values X₁ to X₅ may be determined in advance by a user (user) of the present system. Furthermore, the values X₁ to X₅ may be determined by machine learning. For example, whether or not the selected path has actually been passed may be acquired as result information, and the values X₁ to X₅ may be learned by a method such as regression analysis by using data including the acquired result information and X₁ to X₅ as training data. The values X1 to X5 may be tuned manually by the user.

X₁ to X₅ may be the same value regardless of a travel environment (for example, an office, a factory, an outdoor site, an outdoor public/private road, and the like), or X₁ to X₅ may be weighted depending on the travel environment. The weighting can be calculated by calculating weight coefficients W₁ to W₅ for X₁ to X₅, for example. The weighting may be performed manually by the user or may be performed by using machine learning.

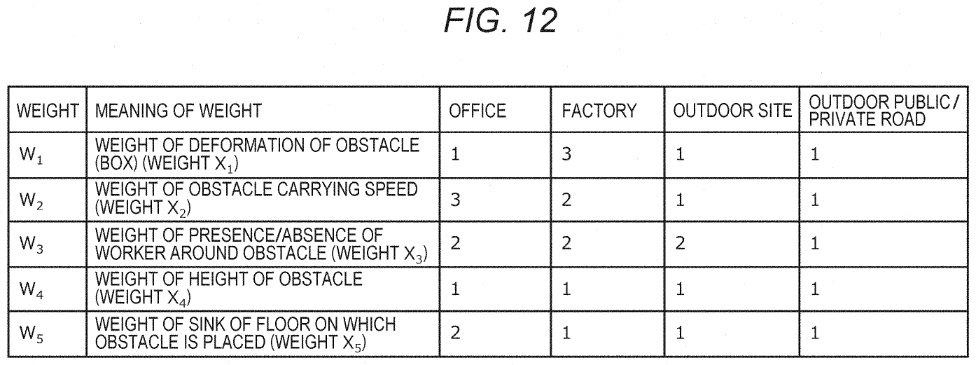

FIG. 12 is a diagram illustrating an example in which X₁ to X₅ is weighted for Office, Factory, Outdoor site, and Outdoor public/private road as travel environments. The travel environments listed in FIG. 12 is an example, and other examples are also possible.

In a case of an office, it is conceivable that an obstacle is handled relatively gently. Therefore, it is assumed that the obstacle or a box as the obstacle are hardly deformed regardless of weight of the obstacle, and a weight W₁ of X₁ is set to a small value (1 in the example in the drawing). Because a floor of an office is often flat and people often carry a package with a cart or by hand, it is assumed that the carrying speed is high if the obstacle is light and the carrying speed is low if the obstacle is heavy. Therefore, the weight W₂ of X₂ is set to a large value (3 in the example in the drawing). Furthermore, in a case where there is a worker around the obstacle, it is assumed that the worker is likely to move the obstacle to another robot passing by, and therefore, the weight W₃ of X₃ is set to a medium value (2 in the example in the drawing). Because it is assumed that the height of the obstacle is unlikely to depend on the travel environment, the weight W₄ of X₄ is set to a low value (1 in the example in the drawing) regardless of the travel environment. Furthermore, a floor of an office may have a double bottom where cables can be laid, and panels may be laid on a surface of the floor. In this case, a heavy object is likely to sink if placed on the panel, and thus, the weight W₅ of X₅ is set to the medium value (2 in the example in the drawing).

The weights W₁ to W₅ of X₁ to X₅ can be similarly determined for travel environments other than an office. For example, because it is assumed that heavy objects are frequently handled in a factory, importance is placed on deformation of an obstacle or a box as the obstacle, and the weight W₃ of X1 is set to 3. Furthermore, because it is assumed that a floor of a factory is solid, including concrete or the like, importance is not placed on sinking floor, and the weight W₅ of X5 is set to 1. Furthermore, because it is assumed that, in an outdoor site or on an outdoor public/private road, a road surface condition is worse than in doors, and a speed at which an obstacle is carried is slow in general, the weight W₂ of X2 is set to 1.

It is assumed that, even in the same type of travel environment (for example, in the same office), the weights X₁ to X₅ have different optimum values depending on an actual environment in which the present system is implemented. Adjustment of the weights may be determined for each company that introduces the present system and each environment in which the system is introduced. At this time, the weights may be determined manually or by machine learning. In the machine learning, for example, the weights W₁ to W₅ of X₁ to X₅ may be determined on the basis of a correlation between a period from when the obstacle is placed to when the obstacle is moved and X₁ to X₅.

According to the present embodiment, the information processing unit 110 of the charge station 100 identifies passable paths from among a plurality of paths that can reach a destination point from a departure point of a robot, and selects a path along which the robot travels. With this arrangement, it is possible to reduce possibility that the robot cannot pass in middle of traveling. It is conceivable that, in a case where the robot cannot pass in the middle of traveling, the robot searches for an alternative path and resumes movement along the alternative path. In this case, there is a possibility that power consumption increases and the robot runs out of electricity during the traveling. In the present embodiment, such a situation can be prevented.

### Fourth Embodiment

In the first to third embodiments, cases where a mobile body is a robot have been described. In a fourth embodiment, a case where the mobile body is a vehicle (for example, an EV, a PHV, or the like) on which a person can board will be described. However, the vehicle in the present embodiment may be an automated vehicle on which no person boards. Differences from the first to third embodiments will be mainly described, and the same description as the description of the first to third embodiments will be omitted.

In a case of a vehicle such as an EV or a PHV, it is assumed that the vehicle is charged by using a charging facility installed at a home, a public facility, a commercial facility, or the like. Power is supplied from the charging facility to the vehicle by wire or wirelessly. As an example, the charging facility corresponds to the charge station 100 in the first to third embodiments. Some functions (for example, at least one of an information processing unit 110, a storage unit 160, a wireless communication unit 140, a wired communication unit 150, or a sensor) of the charge station 100 may be mounted on the vehicle.

In addition to the examples described in the first to third embodiments, at least either road traffic information or a dynamic map may be used as travel environment information according to the present embodiment.

Examples of the road traffic information include traffic congestion information, required time, construction information, accident/disabled vehicle information, speed limit, lane restriction, a location of a parking lot, and parking availability information for a parking lot. The road traffic information is acquired from a vehicle information and communication system (VICS) by the vehicle or a charging facility.

The dynamic map is, for example, a map including four layers of dynamic information, semi-dynamic information, semi-static information, and static information. The static information is highly accurate three-dimensional map information, the semi-static information includes traffic regulation plan information, road construction plan information, and the like, the semi-dynamic information includes accident information, traffic congestion information, traffic regulation information, and the like, and the dynamic information includes ITS forecast information (information about a nearby vehicle, a pedestrian, a signal, or the like). The dynamic map is acquired from an external server or the like by the vehicle or a charging facility.

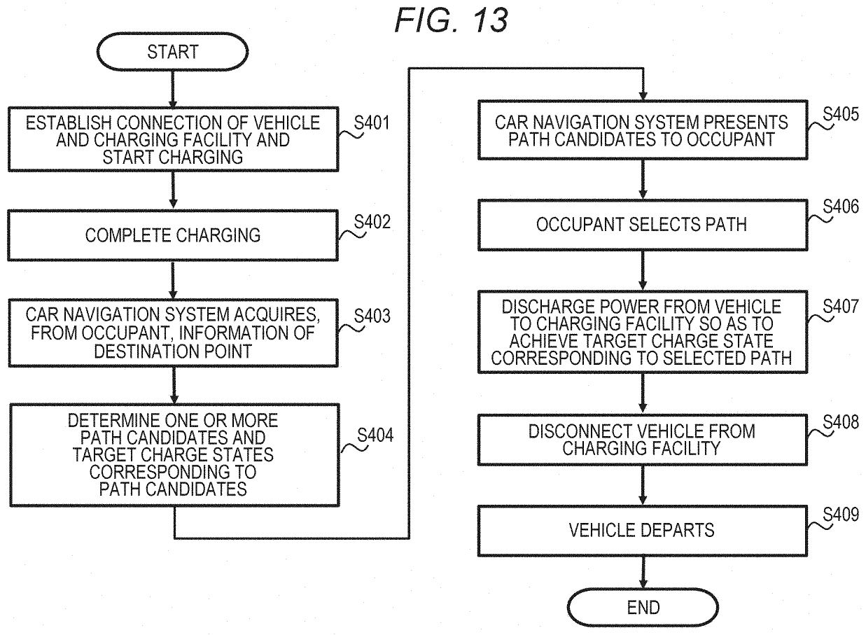

FIG. 13 is a flowchart of an example of operation of a charge control system 10 according to the fourth embodiment.

The vehicle is connected to a charging facility, and the charging facility starts charging a storage battery 230 mounted on the vehicle (S401). The battery may be fully charged or may be charged to a predetermined charge state. When the charge is completed (S402), an occupant of the vehicle sets a destination point in a car navigation system (which may be included in an information processing unit 210 of the vehicle) mounted on the vehicle (S403). The information processing unit 210 of the vehicle or the information processing unit 110 of the charging facility determines one or more path candidates on the basis of the set destination point, and determines a target charge state for each path candidate according to the first embodiment (S404). The car navigation system presents the path candidates on a screen to the occupant (S405). The occupant selects a path to be used for movement from among the presented path candidates (S406). The information processing unit 210 of the vehicle or the information processing unit 110 of the charging facility identifies the target charge state corresponding to the selected path, and a power supply circuit 220 of the vehicle discharges power to the charging facility or charges power from the charging facility to the storage battery 230 to bring the storage battery 230 into the target charge state (S407). In a case of discharging power, it is conceivable to use a vehicle-to-home (V2H) compatible device as the charging facility. The vehicle is disconnected from the charging facility (S408), and the vehicle departs (S409).

The destination point may be set in a navigation system in advance. For example, in a case of a vehicle such as a business vehicle that goes around along a predetermined path, it is conceivable to set a destination point in the navigation system in advance. Furthermore, the storage battery 230 may be charged or discharged not only at a departure point but also at a relay point.

The vehicle may be equipped with a discharge apparatus. In that case, the charging facility and the vehicle can be disconnected before the destination point is input to the navigation system, and power can be discharged from the discharge apparatus of the vehicle in Step S407.

Note that the above-described embodiments describe examples for embodying the present disclosure, and the present disclosure can be implemented in various other forms. For example, various modifications, substitutions, omissions, or combinations thereof can be made without departing from the gist of the present disclosure. Such modifications, substitutions, omissions, and the like are also included in the scope of the present disclosure and are included in the invention described in the claims and the equivalent scope thereof.

Furthermore, the effects of the present disclosure described herein are only examples, and additional effects may also be obtained.

Note that the present disclosure can also have the following configurations.
[Item 1]
   An information processing apparatus including
   a control unit that controls an amount of power charged into a storage battery on the basis of environment information of a path along which a mobile body that moves by using power accumulated in the storage battery moves, the environment information being acquired after start of charge into the storage battery or after charge start instruction.
[Item 2]
   The information processing apparatus according to Item 1, further including
   a processing unit that estimates an amount of regenerative power generated by the mobile body moving along the path on the basis of information regarding the path,
   in which, on the basis of the estimated regenerative power amount, the control unit controls the amount of the power charged into the storage battery.
[Item 3]
   The information processing apparatus according to Item 2,
   in which, on the basis of the regenerative power amount of a plurality of paths and environment information of the plurality of paths, the processing unit selects a path along which the mobile body moves.
[Item 4]
   The information processing apparatus according to any one of Items 1 to 3,
   in which, on the basis of a weight of the mobile body, the control unit controls an amount of power charged into the storage battery.
[Item 5]
   The information processing apparatus according to any one of Items 1 to 4,
   in which, on the basis of a disposition status of an obstacle on a path along which the mobile body moves, the control unit controls an amount of power charged into the storage battery.
[Item 6]
   The information processing apparatus according to Item 5,
   in which the disposition status of the obstacle is based on at least any one of a size of the obstacle, an installation area of the obstacle, disposition density of the obstacles, and the number of the obstacles.
[Item 7]
   The information processing apparatus according to any one of Items 1 to 6,
   in which, on the basis of a road surface condition of a path along which the mobile body moves, the control unit controls an amount of power charged into the storage battery.
[Item 8]
   The information processing apparatus according to Item 7,
   in which the road surface condition is based on at least either a wet-dry condition of a road surface of the path or a material of the road surface of the path.
[Item 9]
   The information processing apparatus according to any one of Items 1 to 8,
   in which, on the basis of a weather condition of an environment of the path, the control unit controls an amount of power charged into the storage battery.
[Item 10]
   The information processing apparatus according to any one of Items 1 to 9,
   in which, on the basis of movement history data of the mobile body, the control unit controls an amount of charge charged into the storage battery.
[Item 11]
   The information processing apparatus according to Item 3,
   in which, on the basis of a disposition status of an obstacle disposed on the plurality of paths, the processing unit selects a path along which the mobile body moves.
[Item 12]
   The information processing apparatus according to Item 11,
   in which the disposition status is based on at least any one of a size of the obstacle, an installation area of the obstacle, disposition density of the obstacles, and the number of the obstacles, on the plurality of paths.
[Item 13]
   The information processing apparatus according to Item 11 or 12,
   in which the processing unit determines, on the basis of information regarding an obstacle disposed on the plurality of paths, whether or not the obstacle is able to be moved, and selects, on the basis of a result of the determination, a path along which the mobile body moves.
[Item 14]
   The information processing apparatus according to Item 13,
   in which the information regarding the obstacle includes at least one item among
   a deformation status of a box as the obstacle,
   a speed of carrying the obstacle when the obstacle is carried to a position where the obstacle is disposed,
   whether or not there is a worker around the obstacle,
   a size of the obstacle,
   a deformation status of a floor on which the
   obstacle is disposed, and
   a weight of the obstacle.
[Item 15]
   The information processing apparatus according to Item 14,
   in which the information regarding the obstacle includes a plurality of the items, and
   the processing unit weights a plurality of the items on the basis of an environment in which the mobile body is operated, and, on the basis of a plurality of the weighted items, determines whether or not the obstacle is able to be moved.
[Item 16]
   The information processing apparatus according to any one of Items 1 to 15, further including
   a processing unit that determines a target charge state of the storage battery on the basis of the environment information,
   in which, on the basis of the target charge state, the control unit controls an amount of power to be charged into the storage battery.
[Item 17]
   The information processing apparatus according to any one of Items 1 to 16, further including a processing unit that acquires the environment information from at least one of a sensor mounted on the mobile body, a sensor mounted on another mobile body, or a sensor installed in an environment in which the mobile body is operated.
[Item 18]
   The information processing apparatus according to any one of Items 1 to 17, further including a sensor that detects the environment information.
[Item 19]
   An information processing method
   that controls an amount of power charged into a storage battery on the basis of environment information of a path along which a mobile body that moves by using power accumulated in the storage battery moves, the environment information being acquired after start of charge into the storage battery or after charge start instruction.
[Item 20]
   An information processing system including
   a mobile body that is equipped with a storage battery and moves by using power accumulated in the storage battery,
   a charge unit that charges the storage battery, and
   a control unit that controls an amount of power charged into the storage battery on the basis of environment information of a path along which the mobile body moves, the environment information being acquired after start of charge into the storage battery or after charge start instruction.

### REFERENCE SIGNS LIST

10 Charge control system
100 Charge station
110 Information processing unit (processing unit)
120 Charge control unit
121 Charge unit
122 Control unit
130 AC/DC power supply circuit
140 Wireless communication unit
150 Wired communication unit
160 Storage unit
170 Sensor (camera or the like)
171 Imaging area (sensing area)
200 Autonomous mobile robot
200, 200A, 200B Robot
210 Information processing unit (processing unit)
220 Power supply circuit
230 Storage battery
300 AC power supply
500 Sensor
500A to 500D Sensor (camera or the like)
501A to 501D Imaging area

1. An information processing apparatus comprising
a control unit that controls an amount of power charged into a storage battery on a basis of environment information of a path along which a mobile body that moves by using power accumulated in the storage battery moves, the environment information being acquired after start of charge into the storage battery or after charge start instruction.

2. The information processing apparatus according to claim 1, further comprising
a processing unit that estimates an amount of regenerative power generated by the mobile body moving along the path on a basis of information regarding the path,
wherein, on a basis of the estimated regenerative power amount, the control unit controls the amount of the power charged into the storage battery.

3. The information processing apparatus according to claim 2,
wherein, on a basis of the regenerative power amount of a plurality of paths and environment information of the plurality of paths, the processing unit selects a path along which the mobile body moves.

4. The information processing apparatus according to claim 1,
wherein, on a basis of a weight of the mobile body, the control unit controls an amount of power charged into the storage battery.

5. The information processing apparatus according to claim 1,
wherein, on a basis of a disposition status of an obstacle on a path along which the mobile body moves, the control unit controls an amount of power charged into the storage battery.

6. The information processing apparatus according to claim 5,
wherein the disposition status of the obstacle is based on at least any one of a size of the obstacle, an installation area of the obstacle, disposition density of the obstacles, and the number of the obstacles.

7. The information processing apparatus according to claim 1,
wherein, on a basis of a road surface condition of a path along which the mobile body moves, the control unit controls an amount of power charged into the storage battery.

8. The information processing apparatus according to claim 7,
wherein the road surface condition is based on at least either a wet-dry condition of a road surface of the path or a material of the road surface of the path.

9. The information processing apparatus according to claim 1,
wherein, on a basis of a weather condition of an environment of the path, the control unit controls an amount of power charged into the storage battery.

10. The information processing apparatus according to claim 1,
wherein, on a basis of movement history data of the mobile body, the control unit controls an amount of charge charged into the storage battery.

11. The information processing apparatus according to claim 3,
wherein, on a basis of a disposition status of an obstacle disposed on the plurality of paths, the processing unit selects a path along which the mobile body moves.

12. The information processing apparatus according to claim 11,
wherein the disposition status is based on at least any one of a size of the obstacle, an installation area of the obstacle, disposition density of the obstacles, and the number of the obstacles, on the plurality of paths.

13. The information processing apparatus according to claim 11,
wherein the processing unit determines, on a basis of information regarding an obstacle disposed on the plurality of paths, whether or not the obstacle is able to be moved, and selects, on a basis of a result of the determination, a path along which the mobile body moves.

14. The information processing apparatus according to claim 13,
wherein the information regarding the obstacle includes at least one item among
a deformation status of a box as the obstacle,
a speed of carrying the obstacle when the obstacle is carried to a position where the obstacle is disposed,
whether or not there is a worker around the obstacle,
a size of the obstacle,
a deformation status of a floor on which the obstacle is disposed, and
a weight of the obstacle.

15. The information processing apparatus according to claim 14,
wherein the information regarding the obstacle includes a plurality of the items, and
the processing unit weights a plurality of the items on a basis of an environment in which the mobile body is operated, and, on a basis of a plurality of the weighted items, determines whether or not the obstacle is able to be moved.

16. The information processing apparatus according to claim 1, further comprising
a processing unit that determines a target charge state of the storage battery on a basis of the environment information,
wherein, on a basis of the target charge state, the control unit controls an amount of power to be charged into the storage battery.

17. The information processing apparatus according to claim 1, further comprising a processing unit that acquires the environment information from at least any one of a sensor mounted on the mobile body, a sensor mounted on another mobile body, or a sensor installed in an environment in which the mobile body is operated.

18. The information processing apparatus according to claim 1, further comprising
a sensor that detects the environment information.

19. An information processing method
that controls an amount of power charged into a storage battery on a basis of environment information of a path along which a mobile body that moves by using power accumulated in the storage battery moves, the environment information being acquired after start of charge into the storage battery or after charge start instruction.

20. An information processing system comprising:
a mobile body that is equipped with a storage battery and moves by using power accumulated in the storage battery;
a charge unit that charges the storage battery; and
a control unit that controls an amount of power charged into the storage battery on a basis of environment information of a path along which the mobile body moves, the environment information being acquired after start of charge into the storage battery or after charge start instruction.
